(19) United States
(12) Patent Application Publication
(10) Pub. No.: US 2013/0073190 A1
(43) Pub. Date: Mar. 21, 2013

(54) Engine Start Up Control For A Motor Vehicle

(71) Applicants: Michael Neisen, Coon Rapids, MN (US); Dan Nagashima, Dublin, OH (US); Todd Luken, Dublin, OH (US); Takahide Mizuno, Dublin, OH (US)

(72) Inventors: Michael Neisen, Coon Rapids, MN (US); Dan Nagashima, Dublin, OH (US); Todd Luken, Dublin, OH (US); Takahide Mizuno, Dublin, OH (US)

(73) Assignee: Honda Motor Co., Ltd., Tokyo (JP)

(21) Appl. No.: 13/238,168

(22) Filed: Sep. 21, 2011

(51) Int. Cl. F02D 28/00

(52) U.S. Cl. 701/113

(57) ABSTRACT

A method of controlling an engine during starting is disclosed. During cold starting and following a refueling, a default alcohol value is used to control various systems associated with the engine, including fuel injection and ignition timing. The default alcohol value is used to ensure reliable starting. During non-cold starting and following a refueling, the current alcohol value is used to minimize fuel inefficiencies.

### BACKGROUND

The present invention relates generally to a motor vehicle, and in particular to a method of controlling engine start up in a motor vehicle.

Methods of controlling an engine during start up have been previously proposed. In vehicles that can run on mixed fuels including gasoline and ethanol, the operation of the engine may be modified according to the concentration of ethanol in the fuel. In some cases, engine starting operations may be modified according to the ethanol content. However, following a refueling event, the ethanol content in the fuel may not be accurately known. In these situations, engine starting can be more difficult.

### SUMMARY

A method and system for controlling engine start up is disclosed. In some embodiments, the method of controlling a motor vehicle includes multiple steps. In some cases, the method includes a step of retrieving a cold start parameter and a step of retrieving a threshold parameter. In some cases, the method also includes a step of determining if an engine is in a cold start condition by comparing the cold start parameter with the threshold parameter. In some cases, a default alcohol value is used to start the engine if the engine is in the cold start condition and a current alcohol value is used to start the engine if the engine is in a condition that is different from the cold start condition. In some cases, the default alcohol value is a constant value and the current alcohol value is variable.

In some embodiments, the method of controlling a motor vehicle includes steps of retrieving alcohol information and engine temperature information. The method can also include steps of retrieving a threshold temperature and determining if an engine temperature is below a threshold temperature. In some cases, a current alcohol value is used to start the engine if the engine temperature is above the threshold temperature, where the current alcohol value associated with an amount of alcohol in a fuel. In some cases, a default alcohol value is used to start the engine if the engine temperature is below the threshold temperature, where the default alcohol value associated with an amount of alcohol in the fuel. In some cases, the default alcohol value is a constant value and where the current alcohol value is variable.

In some embodiments, a method of controlling a motor vehicle includes steps of retrieving alcohol information and engine temperature information. In some cases, the method also includes steps of retrieving fuel level information, retrieving a threshold temperature and determining if a fuel has been added to the motor vehicle. The method can also include a step of determining if an engine temperature is below a threshold temperature. In some cases, a default alcohol value is used to start the engine if the engine temperature is below the threshold temperature and fuel has been added to the motor vehicle, where the default alcohol value being associated with an amount of alcohol in the fuel. In some cases, the default alcohol value is a constant value.

Other systems, methods, features and advantages of the invention will be, or will become, apparent to one of ordinary skill in the art upon examination of the following figures and detailed description. It is intended that all such additional systems, methods, features and advantages be included within this description and this summary, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 is a schematic view of an embodiment of a motor vehicle capable of operating on mixed fuels;

FIG. 2 is an embodiment of a process for controlling engine starting in a motor vehicle;

FIG. 3 is a view of an embodiment of a motor vehicle being refueled at a gas station;

FIG. 4 is a view of an embodiment of a motor vehicle starting immediately following refueling;

FIG. 5 is a view of an embodiment of a motor vehicle being refueled on the side of a road;

FIG. 6 is a view of an embodiment of a motor vehicle starting immediately following refueling;

FIG. 7 is an embodiment of a process for controlling engine starting in a motor vehicle;

FIG. 8 is an embodiment of a detailed process for selecting a default ethanol value as a function of temperature;

FIG. 9 is an embodiment of a process for controlling engine starting in a motor vehicle;

FIG. 10 is an embodiment of a process for controlling engine starting in a motor vehicle; and

FIG. 11 is an embodiment of a process for controlling engine starting in a motor vehicle.

### DETAILED DESCRIPTION

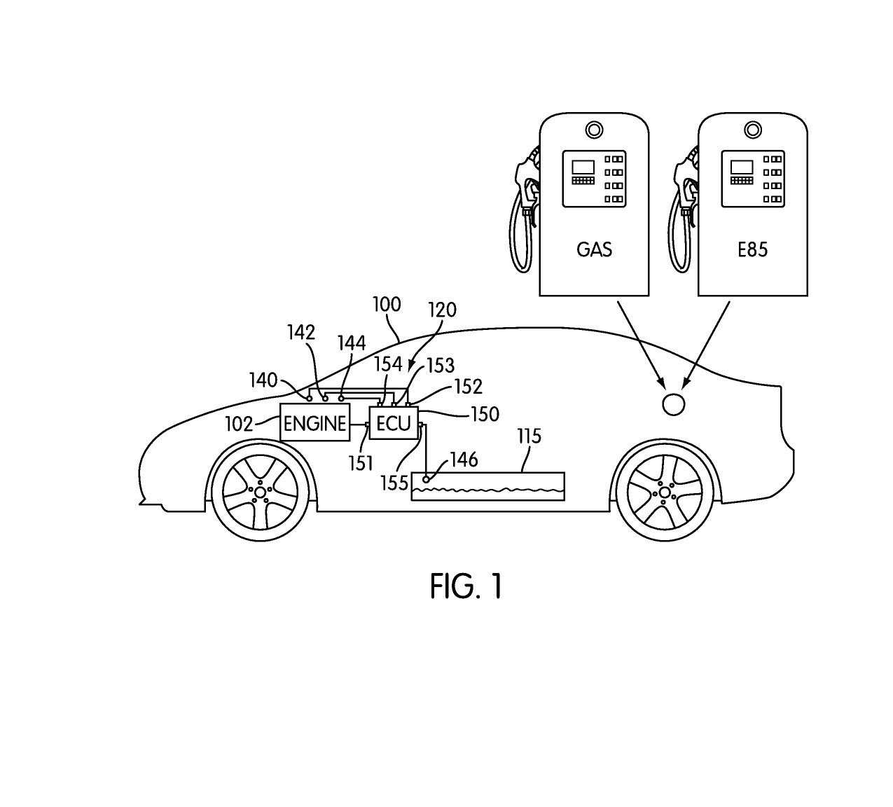

FIG. 1 is a schematic view of an embodiment of motor vehicle 100. The term “motor vehicle” as used throughout this detailed description and in the claims refers to any moving vehicle that is capable of carrying one or more human occupants and is powered by any form of energy. The term “motor vehicle” includes, but is not limited to: cars, trucks, vans, minivans, SUVs, motorcycles, scooters, boats, personal watercraft, and aircraft.

In some cases, the motor vehicle includes one or more engines. The term “engine” as used throughout the specification and claims refers to any device or machine that is capable of converting energy. In some cases, potential energy is converted to kinetic energy. For example, energy conversion can include a situation where the chemical potential energy of a fuel or fuel cell is converted into rotational kinetic energy or where electrical potential energy is converted into rotational kinetic energy. Engines can also include provisions for converting kinetic energy into potential energy. For example, some engines include regenerative braking systems where kinetic energy from a drive train is converted into potential energy. Engines can also include devices that convert solar or nuclear energy into another form of energy. Some examples of engines include, but are not limited to: internal combustion engines, electric motors, solar energy converters, turbines, nuclear power plants, and hybrid systems that combine two or more different types of energy conversion processes.

For purposes of illustration, some components of motor vehicle 100 are shown schematically in this embodiment. In one embodiment, motor vehicle 100 can include engine 102. In some cases, engine 102 may be configured to operate using various types of mixed fuels. The term “mixed fuel” as used throughout this detailed description and in the claims, applies to a mixture of two or more fuels. For example, in some cases, a mixed fuel may be a mixture of gasoline and ethanol. Generally, mixtures of gasoline and ethanol can include different proportions of ethanol including, but not limited to: E20, E75, E80 and E85. In other cases, other types of mixed fuels can be used including, but not limited to: methanol and gasoline mixtures, p-series fuels as well as other mixed fuels.

For purposes of clarity, only some components of motor vehicle 100 are shown in the current embodiment. Furthermore, it will be understood that in other embodiments some of the components may be optional. Additionally, it will be understood that in other embodiments, any other arrangements of the components illustrated here can be used for powering motor vehicle 100.

Motor vehicle 100 can include provisions for controlling engine 102. In some cases, motor vehicle 100 can including control system 120 that is configured to control one or more operations associated with engine 102. For example, in some cases, control system 120 could be used to control one or more fuel injectors associated with engine 102. Also, in some cases, control system 120 could be used to control one or more valves (such as intake or exhaust valves) associated with engine 102. In other cases, control system 120 could be used to control one or more spark plugs or other ignition devices associated with engine 102. In still other cases, control system 120 could be used to control a throttle valve associate with engine 102. In still other cases, control system 120 could be used to control any other systems associated with the operation of engine 102. Moreover, in an exemplary embodiment, control system 120 may be used to control multiple systems associated with engine 102 simultaneously.

Control system 120 may include provisions for communicating, and in some cases controlling, the various components associated with motor vehicle 100. In some embodiments, control system 120 may be associated with a computer or similar device. In the current embodiment, control system 120 may include electronic control unit 150, hereby referred to as ECU 150. In one embodiment, ECU 150 may be configured to communicate with, and/or control, various components of motor vehicle 100. In an exemplary embodiment, ECU 150 may be configured to communicate with and/or control engine 102. For example, in some cases, ECU 150 may be configured to control fuel injectors, spark plugs, valves, a throttle valve, as well as other components associated with engine 102. Furthermore, it should be understood that in some cases, ECU 150 could also be configured to communicate with and/or control various other systems associated with motor vehicle 100.

ECU 150 may include a number of ports that facilitate the input and output of information and power. The term “port” as used throughout this detailed description and in the claims refers to any interface or shared boundary between two conductors. In some cases, ports can facilitate the insertion and removal of conductors. Examples of these types of ports include mechanical connectors. In other cases, ports are interfaces that generally do not provide easy insertion or removal. Examples of these types of ports include soldering or electron traces on circuit boards.

All of the following ports and provisions associated with ECU 150 are optional. Some embodiments may include a given port or provision, while others may exclude it. The following description discloses many of the possible ports and provisions that can be used, however, it should be kept in mind that not every port or provision must be used or included in a given embodiment.

In some embodiments, ECU 150 may include port 151 for communicating with and/or controlling engine 102. In particular, port 151 may be configured to provide communication with fuel injectors, spark plugs, electronically controlled valves, an electronically controlled throttle as well as other systems utilized for the operation of engine 102. For purposes of clarity, a single port is shown in the current embodiment for communicating with various systems of engine 102. However, in other embodiments, ECU 150 could include distinct ports for communicating with fuel injectors, spark plugs, electronically controlled valves, an electronically controlled throttle as well as other systems associated with engine 102. Moreover, in some cases, various sensors associated with the operation of engine 102, including temperature sensors, crank angle sensors and other kinds of sensors may communicate with engine 102 through port 151 or additional ports not shown. With this arrangement ECU 150 can send various control signals to injectors, spark plugs, valves or other components of engine 102 to control the operation of engine 102.

In some embodiments, control system 120 may include provisions for detecting information about motor vehicle 100. In some cases, control system 120 may include provisions for detecting information about the temperature of engine 102. In one embodiment, control system 120 can include engine temperature sensor 140 for sensing the temperature of engine 102. Generally, engine temperature sensor 140 could be any type of sensor. In some cases, engine temperature sensor 140 may sense the temperature of water or a coolant associated with engine 102. In other cases, engine temperature sensor 140 may sense the temperature of oil associated with engine 102. In still other cases, engine temperature sensor 140 could sense the temperature of air in the vicinity of engine 102. In still other cases, engine temperature sensor 140 could be configured to sense the temperature of engine 102 in any other manner.

In one embodiment, ECU 150 may include port 152 for receiving information from engine temperature sensor 140. Using this arrangement, ECU 150 may be configured to determine the current operating temperature of engine 102. Moreover, in some cases, ECU 150 may use the sensed engine temperature to determine if engine 102 is operating in a cold start condition, as discussed in further detail below.

In some embodiments, control system 120 may include provisions for sensing properties of a fuel used to run engine 102. In some embodiments, control system 120 may include fuel content sensor 142. Generally, fuel content sensor 142 may be any type of sensor that is configured to provide information related to one or more properties of a fuel. For example, in some cases, a linear air-fuel (LAF) sensor could be used to provide feedback about the fuel content in an air/fuel mixture associated with engine 102. In other cases, an alcohol content sensor could be used for directly sensing the concentration of an alcohol in a fuel. For example, in one embodiment, fuel content sensor 142 may be an ethanol concentration sensor that senses the concentration of ethanol in a mixed fuel. In still other embodiments, fuel content sensor 142 may be used for sensing any other properties of a fuel. Moreover, while the current embodiment illustrates a single fuel content sensor, in other embodiments two or more fuel content sensors could be used.

In one embodiment, fuel content sensor 142 may be a linear air-fuel sensor that is disposed in an exhaust manifold of engine 102. Information from fuel content sensor 142 may be received at ECU 150. In particular, ECU 150 may receive fuel content information through port 153. Using this arrangement, ECU 150 may be configured to estimate the alcohol content of a fuel according to the fuel content information received from fuel content sensor 142. In an exemplary embodiment, ECU 150 may be configured to estimate the ethanol content of a fuel according to the fuel content information received from fuel content sensor 142.

As previously discussed, in some embodiments, motor vehicle 100 could include provisions for sensing alcohol content directly. For example, in some embodiments, one or more fuel content sensors could be disposed in any location that is in contact with fuel or fuel vapors. In some cases, a fuel content sensor could be disposed in a fuel tank. In other cases, a fuel content sensor could be disposed on a portion of a fuel line connecting a fuel tank to an engine. In still other cases, a fuel content sensor could be disposed in any portion of an engine that is in contact with fuel or fuel vapors.

In some embodiments, control system 120 could include provisions for sensing other operating parameters associated with an engine. For example, in some cases, an engine water level or coolant level could be sensed using fluid level sensor 144. In some cases, ECU 150 could include port 154 for receiving information from fluid level sensor 144. In one embodiment, information from fluid level sensor 144 could be used to determine if engine 102 is operating in a cold start condition.

In some embodiments, control system 120 can include provisions for sensing the amount or level of a fuel in fuel tank 115 of motor vehicle 100. In the current embodiment, control system 120 may be associated with fuel level sensor 146. Generally, fuel level sensor 146 may be any type of sensor that is capable of detecting the fuel level within a fuel tank. In some embodiments, control system 120 could also include provisions for sensing fuel within one or more fuel lines of the motor vehicle. For example, in some cases, control system 120 may include one or more fuel detecting sensors at one or more locations inside a fuel line.

In an embodiment, ECU 150 may include port 155 for receiving information from fuel level sensor 146. Using this arrangement, control system 120 may be configured to determine when a vehicle has recently refueled, since the fuel level within fuel tank 115 will generally rise as new fuel is added. Moreover, in vehicles capable of operating on different types of fuels, a refueling event may signal the possibility that the fuel content has changed. For example, if the fuel content prior to refueling was mostly gasoline, but the vehicle was refueled with an E85 ethanol-gas mixture, the fuel content will vary. Therefore, control system 120 may be configured to modify the operation of one or more systems according to the new fuel content as discussed in detail below.

A control system can include provisions for determining how to control one or more systems associated with engine 102 during start up. In vehicles that run on mixed fuels, it may be necessary to determine one or more properties of the mixed fuel in order to operate engine 102 efficiently. For example, fuels with high alcohol content often require larger injection quantities to achieve efficient combustion over fuels with lower or no alcohol content. In some cases, control system 120 may use information from fuel content sensor 142 to determine an alcohol value. The term “alcohol value” refers to any parameter that is associated with the concentration or amount of alcohol in the fuel. In an exemplary embodiment, the alcohol value may be an ethanol value that is associated with concentrations of ethanol in the fuel. However, in other embodiments, the alcohol value can be associated with any other kinds of alcohols including, but not limited to: methanol, ethanol, butanol, propanol as well as any other kinds of alcohols. The alcohol value may be used to determine the fuel injection quantity, fuel injection start time, fuel injection end time, ignition timing as well as other operating parameters for controlling engine 102. In an exemplary embodiment, the alcohol value may be calculated from information provided from a linear air-fuel sensor.

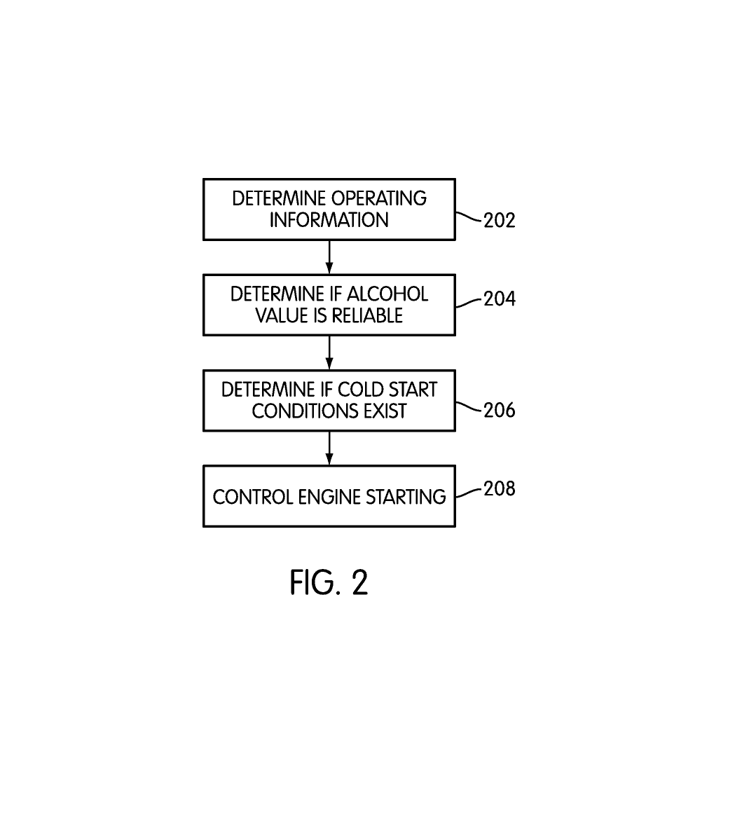

FIG. 2 illustrates an embodiment of a process for starting an engine in a motor vehicle. In some embodiments, some of the following steps could be accomplished by a control system of a motor vehicle. In some cases, some of the following steps may be accomplished by an ECU of a motor vehicle. In other embodiments, some of the following steps could be accomplished by other components of a motor vehicle. It will be understood that in other embodiments one or more of the following steps may be optional.

During step 202, control system 120 may determine operating information. In some cases, the operating information can include alcohol content information. More specifically, in some cases, the operating information can include ethanol content information. In addition, the operating information can include engine temperature. As previously discussed, in some cases, the alcohol content information may be determined from fuel content sensor 142 (see FIG. 1). Likewise, in some cases, engine temperature information can be determined from engine temperature sensor 140.

Typically, an alcohol value may be stored in memory prior to an engine shut-off event. During the process of restarting the engine, the alcohol value may be retrieved. However, in situations where a vehicle has been refueled, the alcohol content of the fuel may vary significantly from the stored value. Therefore, in some situations the stored or current alcohol value may not be an accurate value.

Following step 202, during step 204, control system 120 may determine if the current alcohol value is reliable. In particular, control system 120 may receive information from fuel level sensor 146 to determine if the fuel level has changed since the last engine shut-off event. If the fuel level has not changed, control system 120 may determine that the current alcohol value is reliable. If the fuel level has changed, indicating a refueling event, control system 120 may determine that the current alcohol value is not reliable.

Next, during step 206, control system 120 may determine if cold start conditions exist. In some cases, cold start conditions can be determined by comparing the engine temperature with a threshold temperature. In other cases, cold start conditions can be determined by comparing the water or coolant level with a threshold level. In still other cases, cold start conditions can be determined in any other manner.

Following step 206, control system 120 may proceed to step 208. During step 208, control system 120 may control engine starting according to the operating conditions discussed above.

Engine starting may generally be sensitive to the alcohol value, or alcohol concentration of the fuel, during cold start conditions. As previously discussed, fuel injection and ignition timing, as well as other operating parameters, may be modified according to the alcohol value. Therefore, if the current alcohol value is not reliable, engine starting problems can occur. In some cases, a control system may use a default alcohol value to control one or more systems to ensure that the engine starts. The term “default alcohol value” as used throughout this detailed description and in the claims refers to any constant alcohol value that does not vary according to the alcohol content of fuel in a fuel tank. In some cases, the default alcohol value may not vary over the lifetime of the motor vehicle. In other embodiments, however, the default alcohol value could be adjusted to accommodate changes in the operation of various engine systems with time. In some embodiments, the default alcohol value may be set during manufacturing. In other embodiments, the default alcohol value may selected from a set of constant alcohol values according to some operating parameter such as engine temperature. In contrast, the term “current alcohol value” is used throughout this detailed description and in the claims to refer to any real-time, or learned alcohol value that can vary during operation of the motor vehicle. In some cases, the current alcohol value is determined using information related to one or more fuel content sensors. In other words, the current alcohol value changes as the fuel content of the fuel used to operate the motor vehicle changes while the default alcohol value remains constant at all times. In an exemplary embodiment, the default alcohol value is a default ethanol value. In addition, in an exemplary embodiment, the current alcohol value is a current ethanol value. However, in other embodiments, the default alcohol value and the current alcohol value can be associated with any other types of alcohol.

In some cases, a default alcohol value may be associated with a high ethanol content so that a large fuel injection quantity is used. Using a large fuel injection quantity greatly increases the likelihood of the engine starting regardless of the actual ethanol concentration. However, using a default alcohol value to start the engine after each refueling event can lead to fuel inefficiencies.

A control system can include provisions for selecting an alcohol value in a manner at start up that minimizes fuel inefficiencies. In some embodiments, the control system may only use a default alcohol value after a refueling event and in cold start conditions. In some cases, the control system may use a default alcohol value following a refueling event when the fuel supply is completely exhausted prior to the refueling event (i.e., when the vehicle has run out of fuel and been refueled). In other cases, the control system may use a default value when a vehicle has been driven for a short period of time following a refueling event so that the fuel supply in the fuel lines has been exhausted. In still other cases, the control system may use a default alcohol value following any refueling event, as long as cold start conditions exist. Moreover, when an engine is not in a cold start condition, the current alcohol value may be used for engine starting, even if the current value is not an accurate value since engine starting is less sensitive to ethanol content when the engine is warm.

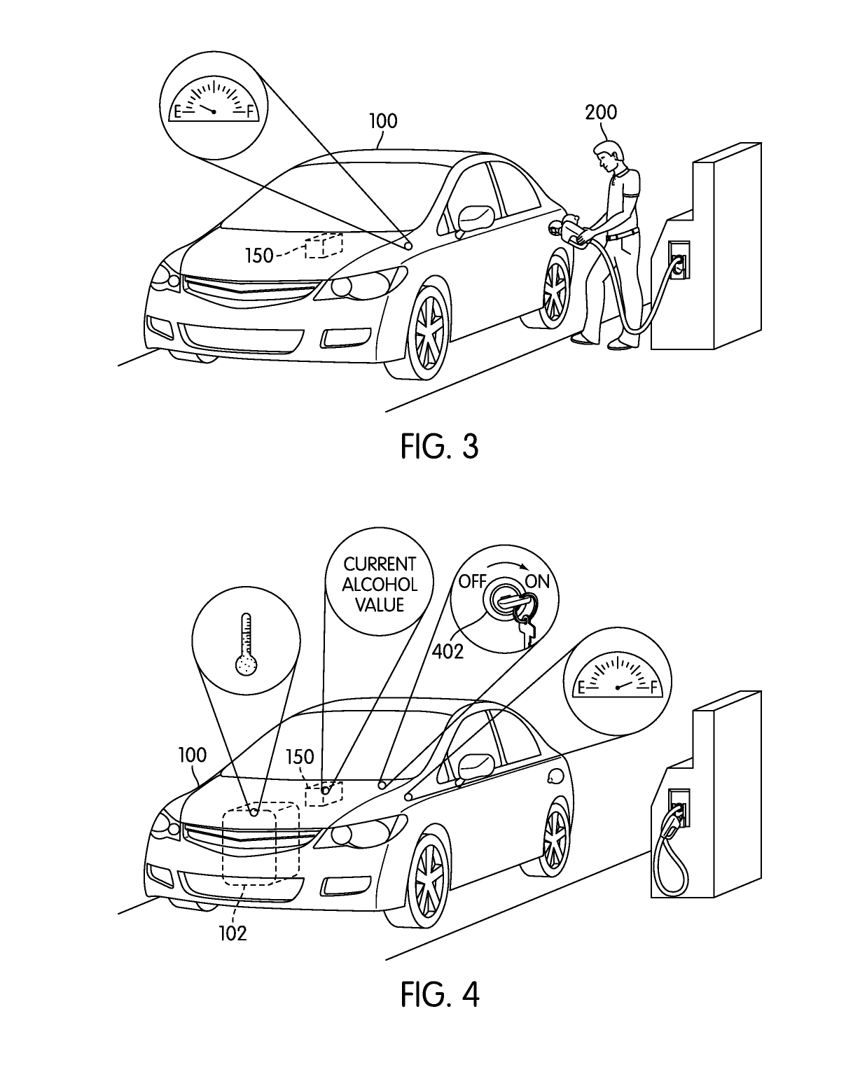

FIGS. 3 and 4 are intended to illustrate one possible embodiment of the operation of control system 120. Referring to FIGS. 3 and 4, user 200 may stop at a gas station to refuel motor vehicle 100. Since motor vehicle 100 is configured to operate on a mixed fuel, user 200 could refuel motor vehicle 100 with any kind of mixed fuel including gasoline and/or E85 fuel. Prior to fueling, the current fuel level may be stored in memory by ECU 150.

After refueling, as seen in FIG. 4, user 200 may start motor vehicle 100 by turning ignition 402. At this point, ECU 150 may determine an alcohol value to be used in controlling the fuel injection and ignition timing as well as other systems required for operating engine 102. In the current situation, control system 120 may determine that a refueling event has occurred. Therefore, the current alcohol value may be unreliable. However, since engine 102 is still relatively warm, control system 120 determines that engine 102 can be started using the current alcohol value. The current alcohol value may be used, even though it may be unreliable, because engine starting is less sensitive to the actual ethanol content of the fuel when engine 102 is warm. This arrangement helps to ensure that engine 102 will start after a refueling event, while minimizing fueling inefficiencies that would occur by using a default alcohol value.

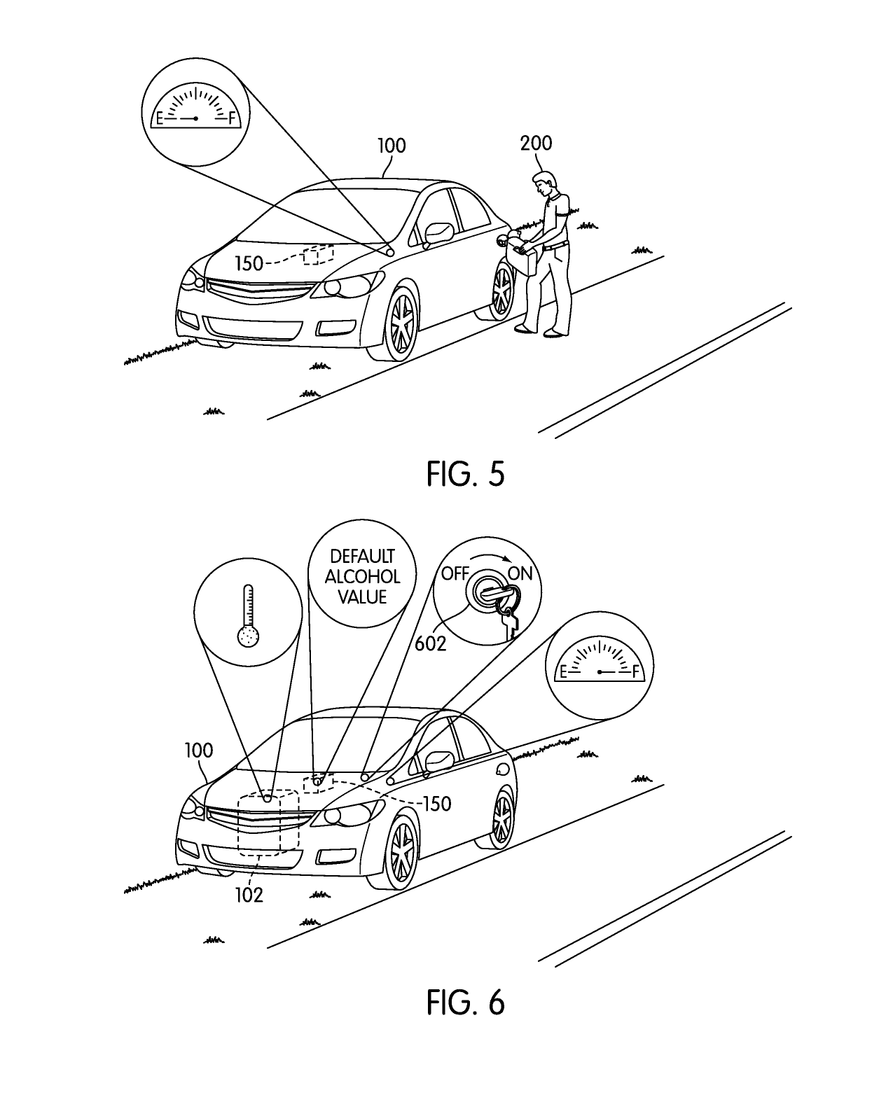

FIGS. 5 and 6 are intended to illustrate another embodiment of the operating of control system 120. Referring to FIGS. 5 and 6, motor vehicle 100 is being refueled by user 200 after previously running out of gas on the side of the road. In this case, a substantial amount of time has passed since engine 102 has been shut down. During the time that user 200 may have gone to retrieve fuel, engine 102 has cooled off.

After refueling, as seen in FIG. 6, user 200 may start motor vehicle 100 by turning ignition 602. At this point, ECU 150 may determine an alcohol value to be used in controlling the fuel injection and ignition timing as well as other systems required for operating engine 102. In the current situation, control system 120 may determine that a refueling event has occurred. Therefore, the alcohol value may be unreliable. Moreover, engine 102 is in a cold start condition. In this cold start condition, engine starting may be sensitive to the actual ethanol content of the fuel. Therefore, ECU 150 uses a default alcohol value instead of the current alcohol value, in order to ensure that engine 102 will start. The default value may be a value that increases the chances of engine 102 starting for a wide range of possible ethanol concentrations in the fuel.

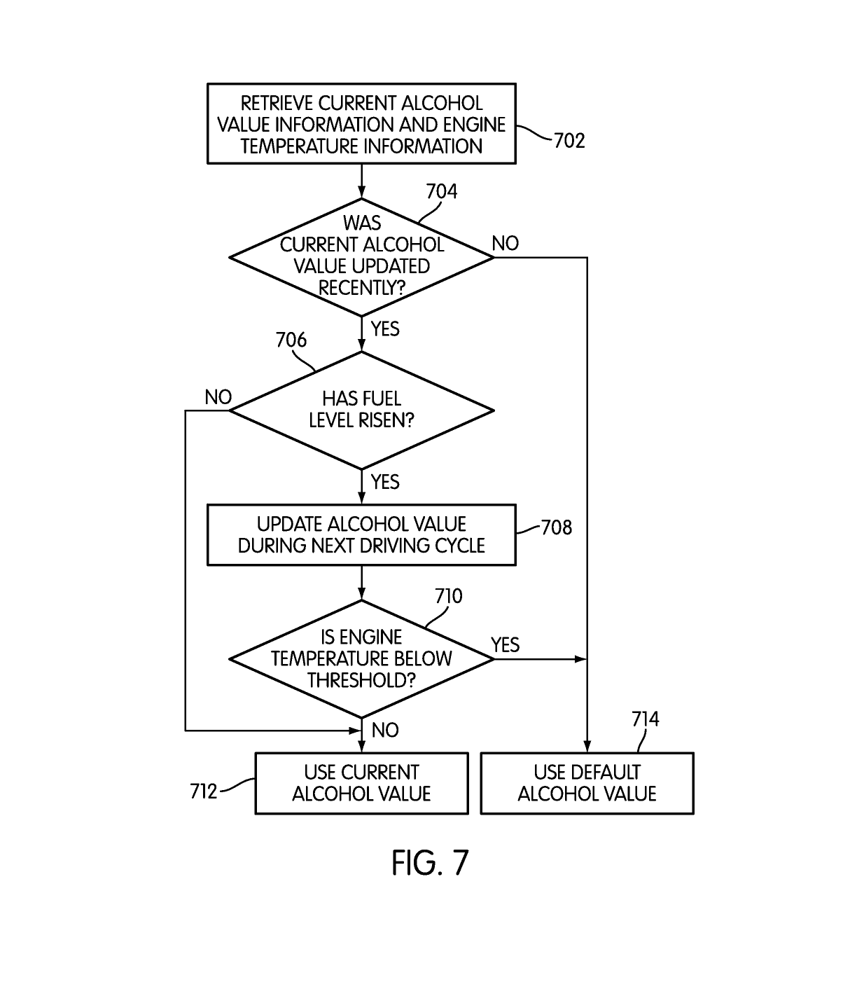

FIG. 7 illustrates an embodiment of a process for starting an engine in a motor vehicle. In some embodiments, some of the following steps could be accomplished by a control system of a motor vehicle. In some cases, some of the following steps may be accomplished by an ECU of a motor vehicle. In other embodiments, some of the following steps could be accomplished by other components of a motor vehicle. It will be understood that in other embodiments one or more of the following steps may be optional.

During step 702, control system 120 may retrieve information related to the current alcohol value. The current alcohol value may be stored in memory. In particular, the current alcohol value may be the most recent alcohol value that has been determined using information from fuel content sensor 142. During step 702, control system 120 may also retrieve information related to the engine temperature.

Next, during step 704, control system 120 may determine if the alcohol value was updated recently. For example, a situation may arise where the driving cycle (engine start to engine shut-off) is not long enough following a refueling event to update the alcohol value. In such a situation, the alcohol value may not be reliable even though the engine has been operated since the most recent refueling event. If the alcohol value was not updated recently, control system 120 may proceed to step 714. During step 714, the default alcohol value is used to start the engine. If however, during step 704, control system 120 determines that the alcohol value was updated recently, control system 120 proceeds to step 706.

During step 706, control system 120 determines if the fuel level has risen. In other words, control system 120 determines if there has been a refueling event. The fuel level may be sensed by fuel level sensor 146, for example. If the fuel level has not risen, control system 120 proceeds to step 712. During step 712, control system 120 uses the current alcohol value during engine starting. If, during step 706, control system 120 determines that the fuel level has risen, control system 120 proceeds to step 708.

During step 708, control system 120 notifies all relevant systems that refuel has occurred and that the alcohol value should be updated during the next drive cycle. Next, during step 710, control system 120 determines if the engine temperature is below a threshold temperature. If the engine temperature is below the threshold temperature, then engine 102 is operating in a cold start condition and therefore proceeds to step 714. During step 714, the default alcohol value is used during engine starting. If, however, control system 120 determines during step 710 that the engine temperature is not below the threshold temperature, control system 120 proceeds to step 712. During step 712, control system 120 uses the current alcohol value during engine starting.

A method of controlling engine starting can include provisions for varying a default alcohol value according to various different operating parameters. For example, in some cases, lower engine temperatures can be associated with higher default alcohol values in order to help ensure that a motor vehicle starts. In other words, a default alcohol value can be selected from a set of two or more default alcohol values according to any kind of operating parameters.

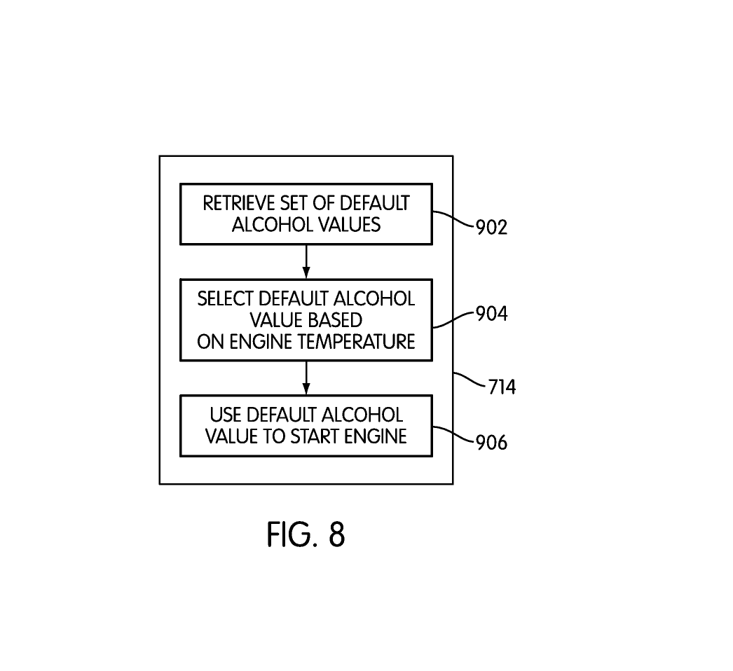

FIG. 8 illustrates an embodiment of detailed steps for using a default alcohol value in situations where multiple different alcohol values are provided as a function of one or more operating parameters. During step 902, control system 120 may retrieve a set of default alcohol values. In some cases, the set of default alcohol values may be stored as a lookup table of some kind. In other cases, the default alcohol values can be stored in any other manner. Moreover, the default alcohol values could be stored in the memory of the ECU or as part of a separate database or memory system. Next, during step 904, control system 120 may select a default alcohol value based on an operating parameter. In some cases, the operating parameter may be temperature since vehicle start up may be effected by engine temperature. In other cases, however, the operating parameter could be any other parameter associated with any vehicle system or ambient conditions. In some cases, the different default alcohol values in the set of default alcohol values may each be associated with different temperatures. Therefore, control system 120 may select the desired default alcohol value as a function of engine temperature. Next, during step 906, control system 120 may use the selected default alcohol value to start the engine. This arrangement helps to minimize fuel inefficiencies by using a default alcohol value that is large enough to ensure start up in cold start conditions over a range of different temperatures.

Although the current embodiment uses engine temperature as an indicator for determining cold start conditions for an engine, in other embodiments any other operating parameter could be used. The term “cold start parameter” as used throughout this detailed description and in the claims refers to any operating parameter that may be used to determine if an engine is in a cold start condition. For example, other examples of cold start parameters include, but are not limited to: water levels, coolant level, oil temperature, air temperature as well as any other parameters known in the art for determining if an engine is in a cold start condition.

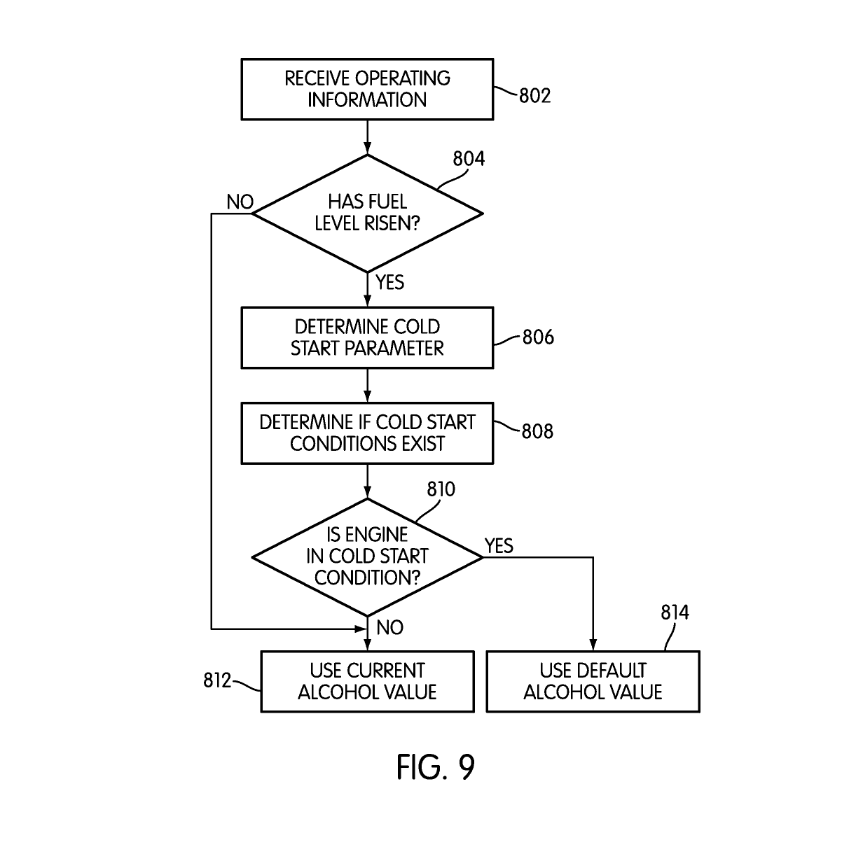

FIG. 9 illustrates an embodiment of a process for starting an engine in a motor vehicle. In some embodiments, some of the following steps could be accomplished by a control system of a motor vehicle. In some cases, some of the following steps may be accomplished by an ECU of a motor vehicle. In other embodiments, some of the following steps could be accomplished by other components of a motor vehicle. It will be understood that in other embodiments one or more of the following steps may be optional.

During step 802, control system 120 may receive operating information. The operating information can include any information sensed by engine temperature sensor 140, fuel content sensor 142, fluid level sensor 144, fuel level sensor 146 as well as any other kinds of sensors capable of receiving information related to other kinds of operating parameters.

Next, during step 804, control system 120 may determine if the fuel level has risen. In some cases, control system 120 may receive information about the fuel level from fuel level sensor 146. If the fuel level has risen, control system may proceed to step 806, otherwise, control system 120 may proceed to step 812.

During step 806, control system 120 determines a cold start parameter. The cold start parameter can include, but is not limited to: engine temperature, water level, coolant level, coolant temperature, oil temperature, air temperature as well as any other operating parameters associated with the operating of engine 102. Next, during step 808, control system 120 may determine if cold start conditions exist. In some cases, control system 120 may compare the cold start parameter with a threshold parameter. For example, if the cold start parameter is water level, the threshold parameter may be a threshold level. If the cold start parameter is an oil temperature, the threshold parameter may be a threshold temperature.

Next, during step 810, control system 120 may determine if the engine is in a cold start condition. If so, control system 120 may proceed to step 814. Otherwise, control system 120 may proceed to step 812. During step 812, control system 120 uses a current alcohol value to control engine start up. During step 814, control system 120 uses a default alcohol value to control engine start up. Using this arrangement, a default alcohol value may only be used in some engine starting situations following a refueling event, to help improve fuel efficiency.

As previously discussed, in some embodiments a default alcohol value may be used when a fuel supply is completely exhausted prior to a refueling event. In these situations, the alcohol concentration of fuel delivered to the engine following the refueling event is completely unknown. Using a default alcohol value in these cases may help ensure proper engine starting, especially during cold start conditions.

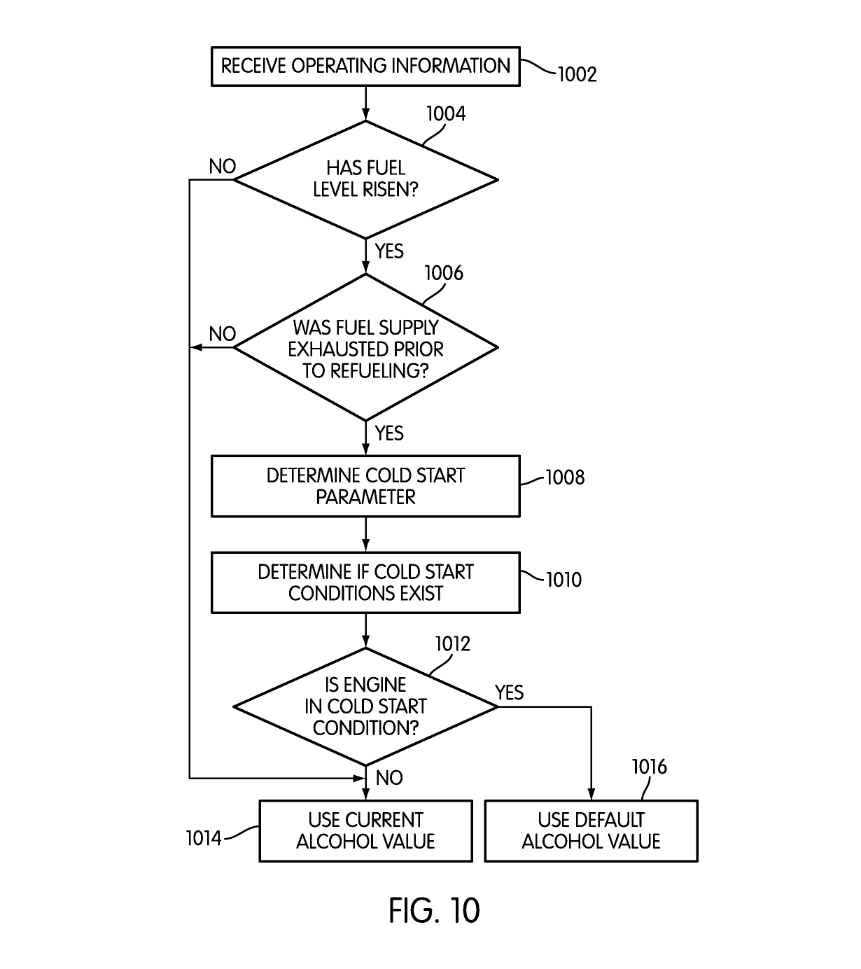

FIG. 10 illustrates an embodiment of a process for starting an engine in a motor vehicle. In some embodiments, some of the following steps could be accomplished by a control system of a motor vehicle. In some cases, some of the following steps may be accomplished by an ECU of a motor vehicle. In other embodiments, some of the following steps could be accomplished by other components of a motor vehicle. It will be understood that in other embodiments one or more of the following steps may be optional.

During step 1002, control system 120 may receive operating information. The operating information can include any information sensed by engine temperature sensor 140, fuel content sensor 142, fluid level sensor 144, fuel level sensor 146 as well as any other kinds of sensors capable of receiving information related to other kinds of operating parameters.

Next, during step 1004, control system 120 may determine if the fuel level has risen. In some cases, control system 120 may receive information about the fuel level from fuel level sensor 146. If the fuel level has risen, control system may proceed to step 1006, otherwise, control system 120 may proceed to step 1014.

During step 1006, control system 120 determines if the fuel supply was exhausted prior to the recent refueling event. In other words, control system 120 determines if the vehicle ran out of fuel before being refueled. In some cases, this may be determined by retrieving stored fuel level information. For example, control system 120 may periodically store fuel level information in memory or in a database. In other cases, when a fuel supply is exhausted, control system 120 may set the value of a parameter to indicate that the vehicle recently ran out of fuel. This parameter could be reset following some preset number of engine cycles after a refueling event.

Following step 1006, during step 1008, control system 120 may determine a cold start parameter. The cold start parameter can include, but is not limited to: engine temperature, water level, coolant level, coolant temperature, oil temperature, air temperature as well as any other operating parameters associated with the operating of engine 102. Next, during step 1010, control system 120 may determine if cold start conditions exist. In some cases, control system 120 may compare the cold start parameter with a threshold parameter. For example, if the cold start parameter is water level, the threshold parameter may be a threshold level. If the cold start parameter is an oil temperature, the threshold parameter may be a threshold temperature.

Next, during step 1012, control system 120 may determine if the engine is in a cold start condition. If so, control system 120 may proceed to step 1016. Otherwise, control system 120 may proceed to step 1014. During step 1014, control system 120 uses a current alcohol value to control engine start up. During step 1016, control system 120 uses a default alcohol value to control engine start up. Using this arrangement, a default alcohol value may be used in some engine starting situations following a refueling event, to help improve fuel efficiency. In particular, a default alcohol value may be used when the fuel supply is completely exhausted prior to a refueling event.

As previously discussed, in some embodiments a default alcohol value may be used when fuel in a fuel supply line is exhausted just after a refueling event and the vehicle is shut off before the control system has time to learn a new alcohol value for the newly added fuel. In particular, if a vehicle is driven for a short period of time following a refueling event, the fuel still present in the fuel lines after the refueling event may have a significantly different alcohol concentration than the fuel in the fuel tank. If the fuel in the fuel lines is exhausted and the vehicle is shut off before the alcohol value of the new fuel can be learned, using the current alcohol value at the next engine start could be problematic. In such cases, the current alcohol value may differ significantly from the actual alcohol value of the fuel at start-up. Therefore, in these situations, it may be desirable to use a default alcohol value to ensure engine start up, especially during cold start conditions.

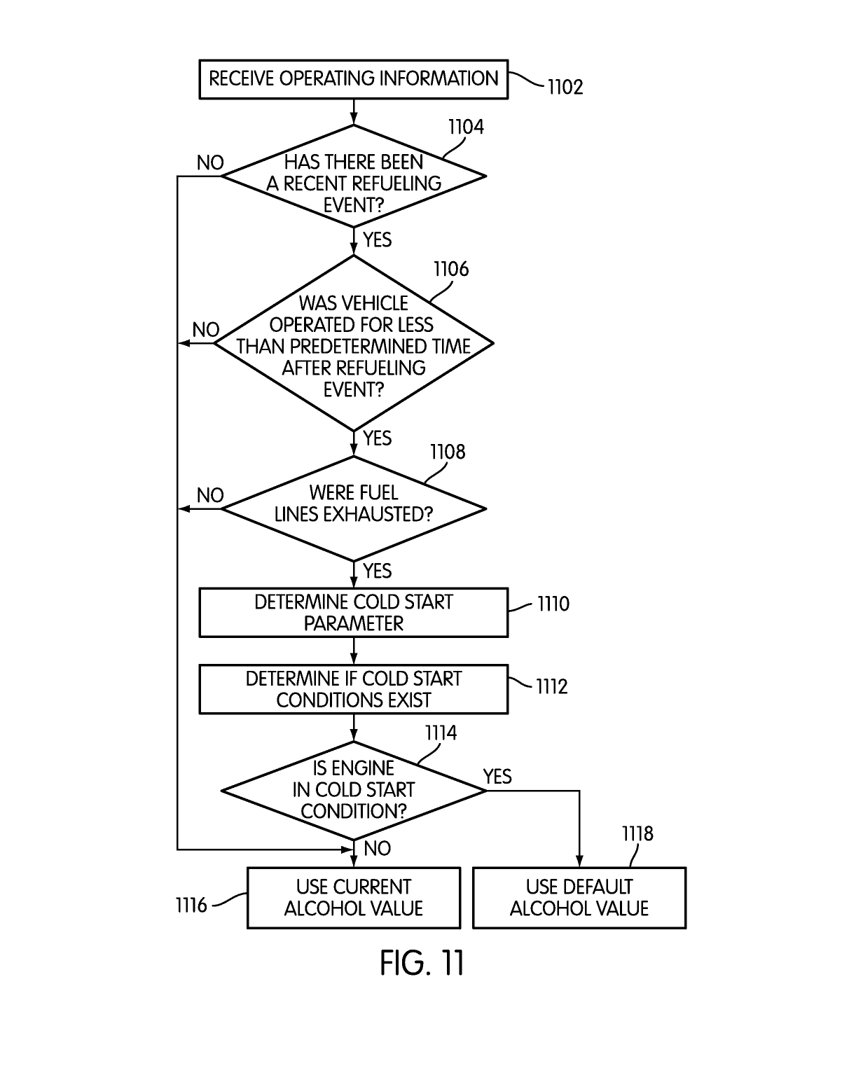

FIG. 11 illustrates an embodiment of a process for starting an engine in a motor vehicle. In some embodiments, some of the following steps could be accomplished by a control system of a motor vehicle. In some cases, some of the following steps may be accomplished by an ECU of a motor vehicle. In other embodiments, some of the following steps could be accomplished by other components of a motor vehicle. It will be understood that in other embodiments one or more of the following steps may be optional.

During step 1102, control system 120 may receive operating information. The operating information can include any information sensed by engine temperature sensor 140, fuel content sensor 142, fluid level sensor 144, fuel level sensor 146 as well as any other kinds of sensors capable of receiving information related to other kinds of operating parameters.

Next, during step 1104, control system 120 may determine if there has been a recent refueling event. The term “recent refueling event” as used throughout this detailed description and in the claims refers to a refueling event that has occurred within a predetermined period of time, or within a predetermined number of engine on/off cycles. In some cases, control system 120 may receive information about recent refueling events from fuel level sensor 146. In other cases, control system 120 may retrieve stored fuel level information to determine if there has been a recent refueling event. If there has been a recent refueling event, control system 120 may proceed to step 1106. Otherwise, control system 120 may proceed to step 1116.

During step 1106, control system 120 determines if the vehicle was operated for a short time after to the most recent refueling event. In some cases, control system 120 may retrieve information about the period of operation from memory or a database. In other words, control system 120 may check to see if the vehicle was operated for a period of time less than some predetermined time. The predetermined time may be a time associated with the average time required to exhaust one or more fuel lines of a motor vehicle. If the vehicle was operated for a short time after the most recent refueling event, control system 120 may proceed to step 1108. Otherwise, control system 120 may proceed to step 1116.

In step 1108, control system 120 may determine if one or more fuel lines were exhausted after the most recent refueling event. In some cases, this information can be estimated using information about the amount of fuel used during an engine cycle as well as fuel line length, diameter, pressure or any other characteristic of one or more fuel lines in a motor vehicle. In other cases, this information can be detected directly from one or more sensors disposed inside a fuel line. Moreover, information about whether fuel was exhausted from a fuel line can be retrieved from memory. If the fuel lines were exhausted, control system 120 may proceed to step 1110. Otherwise, control system 120 may proceed to step 1116.

During step 1110 control system 120 may determine a cold start parameter. The cold start parameter can include, but is not limited to: engine temperature, water level, coolant level, coolant temperature, oil temperature, air temperature as well as any other operating parameters associated with the operating of engine 102. Next, during step 1112, control system 120 may determine if cold start conditions exist. In some cases, control system 120 may compare the cold start parameter with a threshold parameter. For example, if the cold start parameter is water level, the threshold parameter may be a threshold level. If the cold start parameter is an oil temperature, the threshold parameter may be a threshold temperature.

Next, during step 1114, control system 120 may determine if the engine is in a cold start condition. If so, control system 120 may proceed to step 1018. Otherwise, control system 120 may proceed to step 1016. During step 1016, control system 120 uses a current alcohol value to control engine start up. During step 1018, control system 120 uses a default alcohol value to control engine start up. Using this arrangement, a default alcohol value may be used in some engine starting situations following a refueling event, to help improve fuel efficiency. In particular, a default alcohol value may be used when the fuel in a fuel line is completely exhausted immediately following a refueling event and a vehicle is shut off before the control system has time to learn a new alcohol value.

While various embodiments of the invention have been described, the description is intended to be exemplary, rather than limiting and it will be apparent to those of ordinary skill in the art that many more embodiments and implementations are possible that are within the scope of the invention. Accordingly, the invention is not to be restricted except in light of the attached claims and their equivalents. Also, various modifications and changes may be made within the scope of the attached claims.

What is claimed is:

1. A method of controlling a motor vehicle, comprising the steps of:
retrieving a cold start parameter;
retrieving a threshold parameter;
determining if an engine is in a cold start condition by comparing the cold start parameter with the threshold parameter;
using a default alcohol value to start the engine if the engine is in the cold start condition;
using a current alcohol value to start the engine if the engine is in a condition that is different from the cold start condition; and
wherein the default alcohol value is a constant value and wherein the current alcohol value is variable.

2. The method according to claim 1, wherein the cold start parameter is engine temperature.

3. The method according to claim 2, wherein the threshold parameter is a threshold temperature.

4. The method according to claim 1, wherein the cold start parameter is associated with an engine water level.

5. The method according to claim 4, wherein the threshold parameter is a threshold water level.

6. The method according to claim 1, wherein the current alcohol value is a current ethanol value and wherein the default alcohol value is a default ethanol value.

7. The method according to claim 1, wherein the method includes a step of determining if a refueling event has recently occurred.

8. The method according to claim 7, wherein the step of determining if a refueling event has recently occurred includes a step of determining if the motor vehicle has been operated for less than a predetermined time following the refueling event and wherein the default alcohol value is used when the vehicle has been operated for less than the predetermined period time following the refueling event and when the engine is in the cold start condition.

9. The method according to claim 7, wherein the method further includes a step of checking if one or more fuel lines have been exhausted and using the default alcohol value when the one or more fuel lines have been exhausted and the engine is in the cold start condition.

10. The method according to claim 7, wherein the step of determining if fuel has been added to the motor vehicle includes a step of determining if a fuel supply was completely exhausted prior the refueling event.

11. The method according to claim 10, wherein the step of using the default alcohol value includes using the default alcohol value when the fuel supply was completely exhausted prior to the refueling event.

12. A method of controlling a motor vehicle, comprising the steps of:
retrieving alcohol information and engine temperature information;
retrieving a threshold temperature;
determining if an engine temperature is below a threshold temperature;
using a current alcohol value to start the engine if the engine temperature is above the threshold temperature, the current alcohol value associated with an amount of alcohol in a fuel;
using a default alcohol value to start the engine if the engine temperature is below the threshold temperature, the default alcohol value associated with an amount of alcohol in the fuel; and
wherein the default alcohol value is a constant value and wherein the current alcohol value is variable.

13. The method according to claim 12, wherein the current alcohol value is a learned value.

14. The method according to claim 12, wherein the default alcohol value is determined at the time of manufacturing.

15. The method according to claim 12, wherein the default alcohol value is associated with a high alcohol content.

16. The method according to claim 12, wherein the step of determining if the engine temperature is below the threshold temperature is preceded by a step of determining if a fuel level in a fuel tank of the motor vehicle has risen.

17. The method according to claim 16, wherein the default alcohol value is used to start the engine when the engine temperature is below the threshold temperature and when the fuel level has risen.

18. The method according to claim 12, wherein the alcohol information is ethanol information.

19. A method of controlling a motor vehicle, comprising the steps of:
retrieving alcohol information and engine temperature information;
retrieving fuel level information;
retrieving a threshold temperature;
determining if a fuel has been added to the motor vehicle;
determining if an engine temperature is below a threshold temperature;
using a default alcohol value to start the engine if the engine temperature is below the threshold temperature and fuel has been added to the motor vehicle, the default alcohol value being associated with an amount of alcohol in the fuel; and
wherein the default alcohol value is a constant value.

20. The method according to claim 19, wherein a current alcohol value is used when the engine temperature is above the threshold temperature.

21. The method according to claim 19, wherein a current alcohol value is used when a fuel level of a fuel tank is unchanged.

22. The method according to claim 19, wherein the alcohol information is ethanol information.

23. The method according to claim 19, wherein the default ethanol value is associated with a high ethanol content.

24. The method according to claim 21, wherein the current ethanol value is determined using information from a fuel content sensor.

25. The method according to claim 24, wherein the fuel content sensor is a linear air-fuel sensor.
